(19) United States
(12) Patent Application Publication
(10) Pub. No.: US 2003/0012592 A1
(43) Pub. Date: Jan. 16, 2003

(54) Keypad including polyurethane resin, and apparatus and method for fabricating the same

(76) Inventor: Byung Kwan Min, Seoul (KR)

Correspondence Address: HARNESS, DICKEY & PIERCE, P.L.C., P.O. BOX 8910, RESTON, VA, 20195, US

(21) Appl. No.: 10/203,787

(22) PCT Filed: Feb. 14, 2001
(86) PCT No.: PCT/KR01/00214

(30) Foreign Application Priority Data
Feb. 14, 2000 (KR) 2000/6877
Feb. 14, 2001 (KR) 2001/7196

(51) Int. Cl. B41J 5/10

(52) U.S. Cl. 400/490

(57) ABSTRACT

There is provided an electronic product having a keypad including polyurethane resin. A cellular phone (100) as the electronic product has a keypad (P) including the polyurethane resin as a keypad surface and being positioned on a circuit board (6) of the cellular phone (100). A method for fabricating the keypad (P) includes the steps of: (a) printing numerals and characters on button-key portions of a polyurethane film to produce a printed polyurethane film; (b) inserting the printed polyurethane film between a first die and a second die; (c) pressing the printed polyurethane film by compressed air injected into the first die connected to a compressor; (d) adsorbing the printed polyurethane film on a concave surface of the second die by sucking air between the printed polyurethane film and the second die connected to a vacuum pump, thereby forming a base keypad having protrusions formed on the button-key portions; and (e) injecting silicone into insides of the protrusions. There is an advantage that the keypad (P) including the polyurethane resin as the keypad surface is not slippery and soft.

### TECHNICAL FIELD

The present invention relates to a keypad; and more particularly, to a keypad including polyurethane resin, and an apparatus and method for fabricating the same.

### BACKGROUND ART

Conventionally, a conventional keypad, having a plurality of numeral and character keys as a set of button-keys, can be employed in a telephone, a cellular phone or a remote controller. Further, the conventional keypad can be employed in an electric rice cooker, a microwave oven, a medical instrument, a vehicle instrument panel, a security device, a lubricator or a computer keyboard. For example, the cellular phone includes a set of button-key switches being in contact with the set of button-keys and a circuit board coupled to the set of button-key switches. The conventional keypad of the cellular phone is positioned on the circuit board.

The set of button-keys can be made up of a rubber so that a button-key surface is not slippery. However, where the set of button-keys is made up of the rubber, there is a problem that numerals and characters printed on the set of button-keys can be erased.

To solve the problem described above, the numerals and characters are printed on the rear surface of the set of button-keys. At this time, the conventional keypad including there is provided a Keypad having button-keys, comprising: a keypad surface including polyurethane resin.

In accordance with a second aspect of the present invention, there is provided an apparatus for fabricating a keypad, comprising: a first die for pressing a polyurethane film by compressed air; a second die for adsorbing the polyurethane film on a concave surface of the second die by sucking air between the polyurethane film and the second die; a compressor connected to the first die for providing the compressed air into the first die; and a vacuum pump connected to the second die for pumping the sucked air outside the second die.

In accordance with a third aspect of the present invention, there is provided a method for fabricating a keypad, comprising the steps of: (a) printing numerals and characters on button-key portions of a polyurethane film to produce a printed polyurethane film; (b) inserting the printed polyurethane film between a first die and a second die; (c) pressing the printed polyurethane film by compressed air injected into the first die connected to a compressor; (d) adsorbing the printed polyurethane film on a concave surface of the second die by sucking air between the printed polyurethane film and the second die connected to a vacuum pump, thereby forming a base keypad having protrusions formed on the button-key portions; and (e) injecting silicone into insides of the protrusions.

### BRIEF DESCRIPTION OF THE DRAWINGS

The above and other objects and features of the instant invention will become apparent from the following description of preferred embodiments taken in conjunction with the separate upper and lower dies employed in a post-process;

FIG. 13 is an exemplary rear view illustrating a keypad including polyurethane resin after a post-process; and

FIG. 14 is another exemplary perspective view illustrating a keypad including polyurethane resin in accordance with the present invention.

### BEST MODE FOR CARRYING OUT THE INVENTION

Referring to FIG. 1, there is shown an exemplary perspective view illustrating a cellular phone in accordance with the present invention. As shown, a cellular phone 100 includes a circuit board 6 having key switches 4, a keypad P being mounted on the circuit board 6 and a keypad cover 10 having key holes 8. The keypad P includes a keypad surface made up of polyurethane resin. The keypad P includes a set of button-keys K protruded outwardly. The keypad P including the polyurethane resin is soft and not slippery. The keypad P including the polyurethane resin may be deformed at an only high temperature.

Referring to FIG. 4, there is shown an apparatus for fabricating the keypad of the cellular phone shown in FIG. 1. As shown, the apparatus includes a forming device 200 and a cooling device 300. The forming device 200 forms a base keypad having protrusions formed on button-key portions. The cooling device 300 cools the base keypad formed by the forming device 200. If the cooling device 300 cools the base keypad, the shrinkage of the base keypad can be prevented and simultaneously print inks of numerals and characters printed on the base keypad can be protected.

The forming device 200 includes a worktable 31, a guide the coolant circulation plate 85 through the heat exchange plate 97. A fan 99 is positioned on the opposite side of the heat exchange plate 97 wherein the fan 99 provides the cooling air to the heat exchange plate 97. The controller 400 controls drive motors.

Referring to FIG. 5, there is shown an exemplary cross-sectional view illustrating the vertical transfer portion 57 for transferring the upper die 47 shown in FIG. 4. As shown, the vertical transfer portion 57 includes a supporting plate 101, a speed reducer 105, a driving gear 107, driven gears 109, a fixed plate 111 and screws 113. The drive motor 103 is mounted on the supporting plate 101 and electrically connected to the controller 400. The speed reducer 105 is connected to the drive motor 103. The driving gear 107, connected to a shaft 106, is rotated and positioned under the supporting plate 101. The driven gears 109 surround the driving gear 107. Further, the gears 109 are engaged with the driving gear 107. The fixed plate 111 is spaced by a predetermined interval from the supporting plate 101. The screws 113, focused at a rotation center of the driven gears 109, pass through the supporting plate 101 and the fixed plate 111.

Referring to FIG. 6, there is shown an exemplary cross-sectional view illustrating a fixing chuck device contained in the apparatus shown in FIG. 4. As shown, a fixing chuck device 55 includes a cylinder 115, transfer rods 117, chucks 119, drive motors 121, a compressed-air transfer pipe 61 and stopper protrusions 45. The transfer rods 117 are installed on both the end sides of the cylinder 115, respectively. The compressed-air transfer pipe 61 is positioned at the center of the cylinder 115. The chucks 119 are moved by the compressed 133. The fixing fragment 131 is fixed to the lower plate 37. Further, the fixing fragment 131 is horizontally moved along a groove of the cylinder 133.

The compressed-air transfer pipe 59 shown in FIG. 4 is connected to the compressor 81. An injection nozzle 56 is installed on one side of compressed-air transfer pipe 59. The injection nozzle 56 injects the compressed air for cooling toward the lower die 40.

The method for fabricating the keypad including the polyurethane resin in accordance with the present invention is as follows, wherein the polyurethane resin represents the polyurethane resin of “ESMA-URS XTYPE” produced by NIHON MATAI CO, LTD.

Referring to FIG. 9, there is shown an exemplary flow chart illustrating a method for fabricating the keypad including the polyurethane resin. As shown, at step S100, the numerals and characters are printed on button-key portions of a polyurethane film by a printing process. At this time, a printed polyurethane film P1 representing a result of the printing process is produced as shown in FIG. 10.

Hereinafter, at step S200, the printed polyurethane film P1 between the lower die 40 and the upper die 47 is formed into a base keypad by a forming process.

The forming process is detailedly described below.

The printed polyurethane film P1 is put on the lower die 40 having the concave surface. When an operator presses an operation button, the controller 400 operates the drive motor 103 included in the vertical transfer portion 57 shown in FIG. 5. The drive motor 103 operates the speed reducer 105. The speed reducer 105 rotates the driving gear 107 through the shaft into the vacuum pump 83 through the fourth valve 77.

Simultaneously, the controller 400 controls and opens a third valve 75 connected to the compressor 81 as shown in FIG. 4. At step S230, the compressed air for pressing transferred through the third valve 75, presses the printed polyurethane film P1 positioned on the lower die 40 through the compressed-air transfer pipe 63 and the compressed-air injection pipe 125 as shown in FIG. 7 by a press-forming process.

In other words, while the compressed air passing through the upper die 47 presses the printed polyurethane film P1, the printed polyurethane film P1 is adsorbed on the concave surface of the lower die 40. As a result, a base keypad having protrusions formed on the set of button-keys K is formed as shown FIG. 11.

At this time, a temperature of the compressed air can be adjusted in the range of 60° C. to 180° C. by the upper heating plate 51 and a temperature sensor 52. Further, the temperature of the lower die 40 can be adjusted by the lower heating plate 39 and another temperature sensor. Accordingly, the adsorbing and press-forming processes with respect to the printed polyurethane film can be precisely performed.

After the adsorbing and press-forming processes at the steps S210 and S230, the controller 400 controls and opens a fifth valve 79 connected to the compressor 81 as shown in FIG. 4. The compressed air transferred through the fifth valve 79 moves the fixing fragment 131 of the cylinder 133 through the compressed-air transfer pipe 133 as shown in FIG. 8. The fixing fragment 131 moves the lower plate 37 and the lower die 40 along the guide rail 33.

When the lower die 40 is moved, the controller 400 controls coolant, e.g., cooling water, contained in the coolant tank 93. The coolant is in contact with the lower surface of the separate cooling die 87. Further, the coolant is circulated in the inside of the coolant circulation plate 85, thereby decreasing the temperature of the separate cooling die 87.

Since the base keypad including the polyurethane resin is cooled for the time period of three to eight seconds by the coolant and cooling air through the cooling fan 91, the shrinkage of the base keypad can be prevented. Simultaneously, the print ink of numerals and characters printed on the base keypad can be protected.

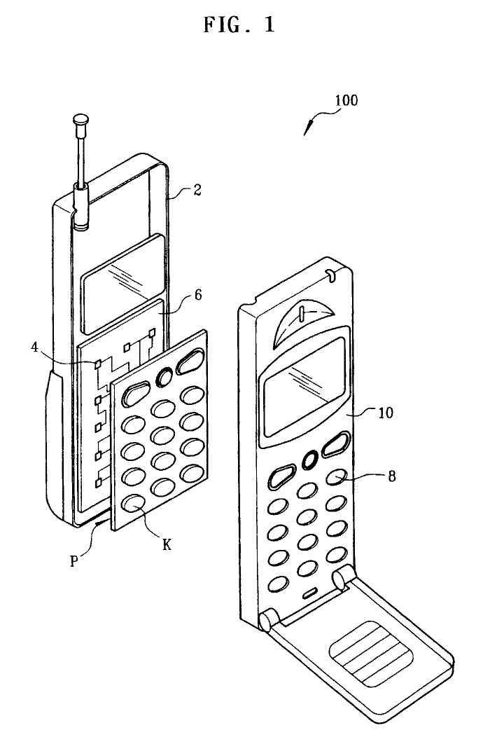

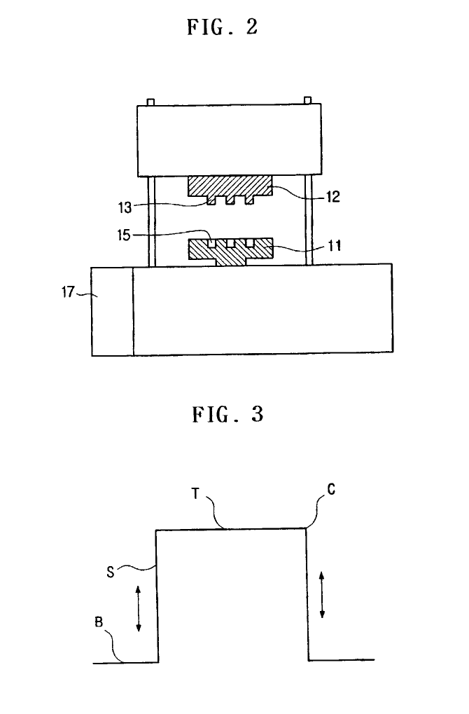

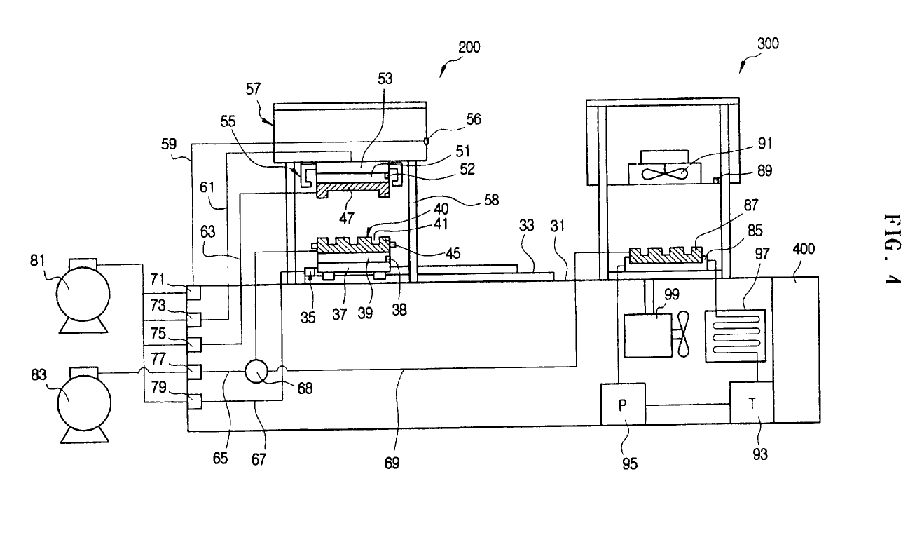

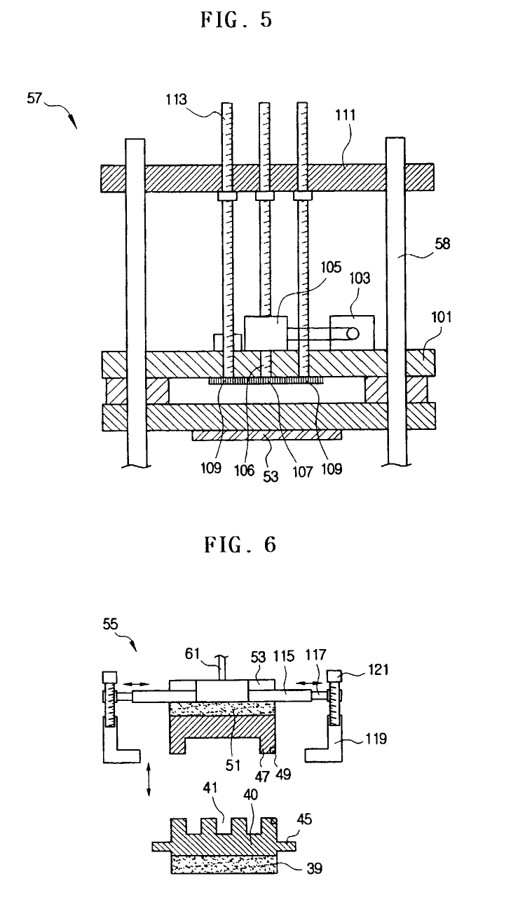

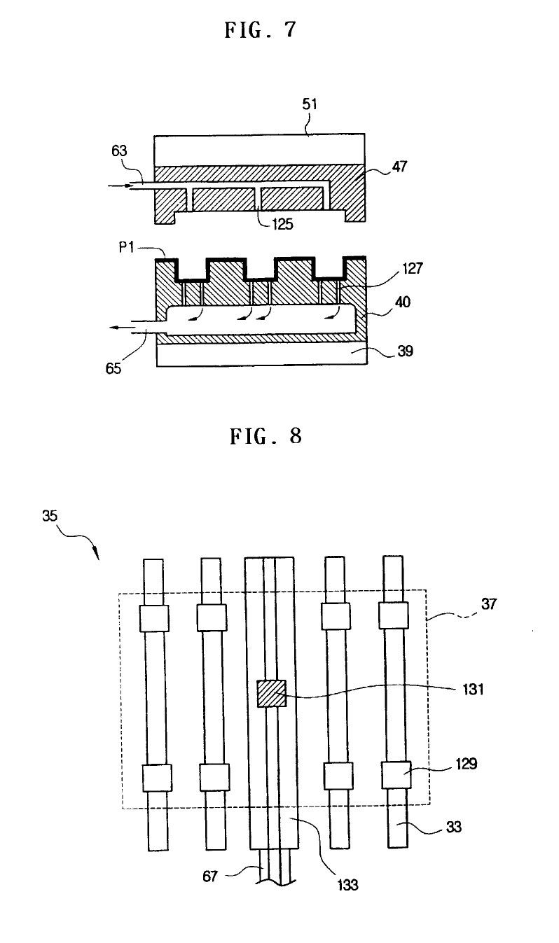

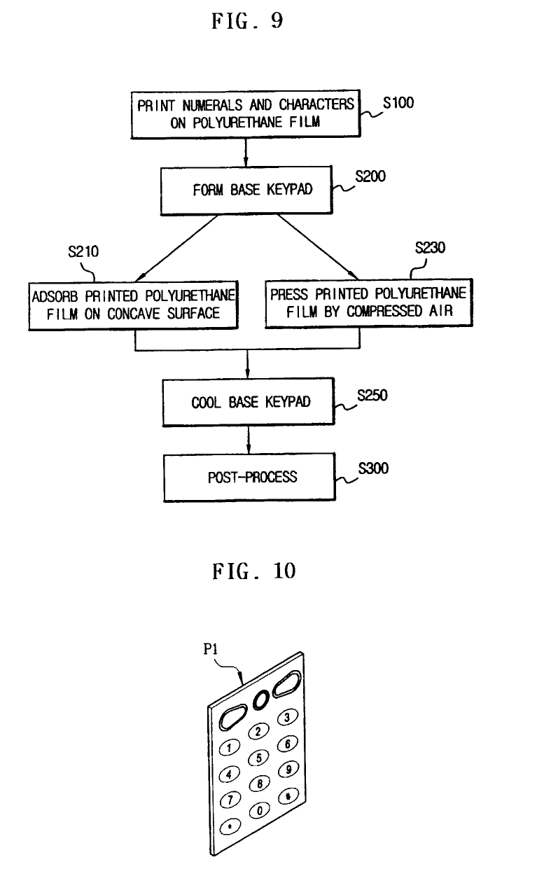

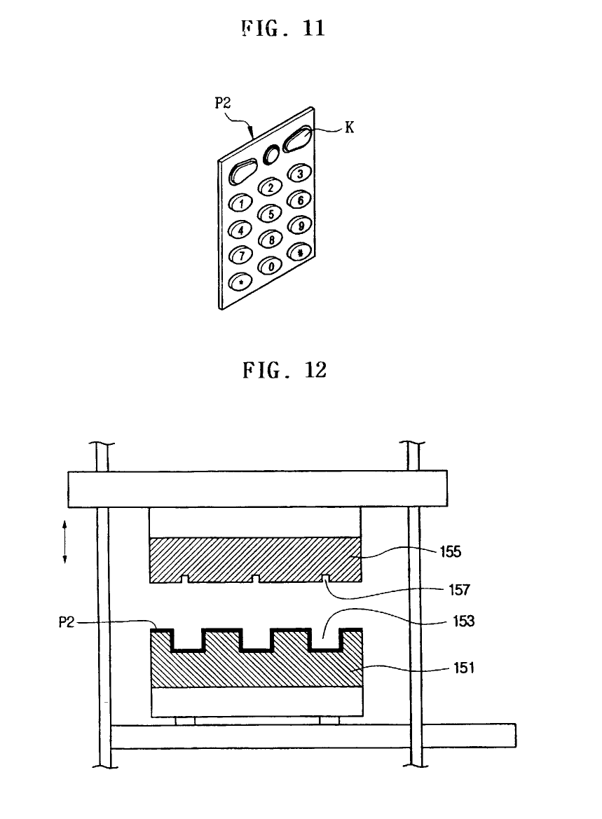

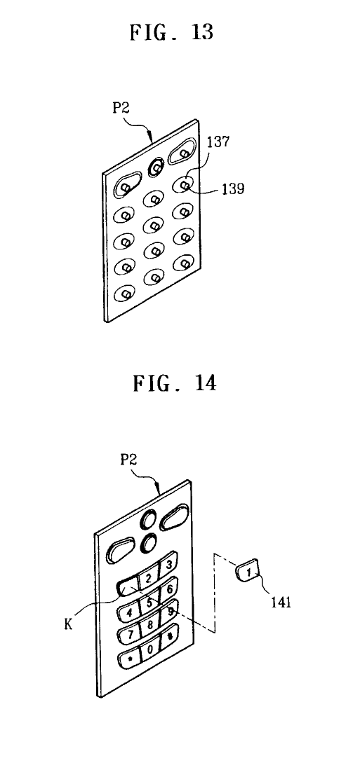

Hereinafter, at step S300, silicone is injected into the inside spaces of the protrusions contained in the base keypad P2 shown in FIG. 13 by a post-process. Accordingly, silicone portions 137 are formed in the inside spaces of the protrusions contained in the base keypad P2. Then, small protrusions 139 are selectively formed on the silicone portions 137 so that the small protrusions 139 can be in contact with key-switches of the cellular phone. The base keypad P2 is cut on the basis of a size of the cellular phone.

Referring to FIG. 12, there is shown an exemplary cross-sectional view illustrating separate upper and lower dies employed in the post-process. As shown, the base keypad P2 is put on a separate lower die 151. The silicone is injected into inside spaces 153 of the button-keys K contained in the base keypad P2. A separate upper die 155 compresses the silicone injected, thereby producing the keypad including the polyurethane resin, wherein the separate upper die 155 has the concave surface corresponding to a set of small protrusions being formed on the silicone.

1. A keypad having button-keys, comprising:
a keypad surface including polyurethane resin.

2. The keypad as recited in claim 1, wherein the button-keys include:
silicone portions formed in insides of the button-keys, the silicone portions having protrusions being in contact with key-switches of a circuit board.

3. The keypad as recited in claim 1 or 2, wherein the button-keys are attached to a button-key cover, respectively.

4. An apparatus for fabricating a keypad, comprising:
a first die for pressing a polyurethane film by compressed air;
a second die for adsorbing the polyurethane film on a concave surface of the second die by sucking air between the polyurethane film and the second die;
a compressor connected to the first die for providing the compressed air into the first die; and
a vacuum pump connected to the second die for pumping the sucked air outside the second die.

5. The apparatus as recited in claim 4, further comprising:
a vertical transfer portion for vertically transferring the first die;
a horizontal transfer portion for horizontally transferring the second die; and
a controller for controlling the vertical transfer portion, die;
a vacuum adsorption pipe positioned in the second die for adsorbing the polyurethane film on the concave surface of the second die by sucking the air between the printed polyurethane film and the second die; and
a vacuum pump pipe, connected to the vacuum pump and passing through the second die, for pumping the sucked air outside the second die.

11. The apparatus as recited in any of claims 4 to 9, further comprising:
a cooling die connected to the vacuum pump for cooling a base keypad separated from the second die, the base keypad representing the polyurethane film pressed by the compressed air;
a coolant circulation plate for circulates a coolant to adjust a temperature of the cooling die;
a heat exchange plate connected to the coolant circulation plate for exchanging the heat of the coolant being circulated in the coolant circulation plate; and
a fan positioned above the cooling die for providing a cooling air to the cooling die.

12. The apparatus as recited in claim 10, further comprising:
a cooling die connected to the vacuum pump for cooling a base keypad separated from the second die, the base keypad representing the polyurethane film pressed by the compressed air;
a coolant circulation plate for circulates a coolant to

16. The method as recited in any of claims 13 to 15, further comprising the step of:
(f) cooling the base keypad for a time period of three to eight seconds with low-temperature air after the steps (c) and (d).

17. The method as recited in claim 16, further comprising the step of:
cooling the base keypad for a time period of two to four seconds with normal-temperature air before the step (f).

18. The method as recited in any of claims 13 to 15, wherein the step (e) further includes the step of:
attaching button-key covers to the button-key portions.

19. The method as recited in claim 17, wherein the step (e) further includes the step of:
attaching button-key covers to the button-key portions.
